(19) United States
(12) Patent Application Publication
(10) Pub. No.: US 2016/0178077 A1
(43) Pub. Date: Jun. 23, 2016

(54) FLUID FLOW DEVICE AND METHOD OF OPERATING SAME

(71) Applicant: Kabushiki Kaisha Kobe Seiko Sho (Kobe Steel, Ltd.), Kobe-shi (JP)

(72) Inventors: Akira MATSUOKA, Kobe-shi (JP); Koji NOISHIKI, Takasago-shi (JP); Tomohiro OOZONO, Takasago-shi (JP)

(73) Assignee: Kabushiki Kaisha Kobe Seiko Sho (Kobe Steel, Ltd.), Kobe-shi (JP)

(21) Appl. No.: 14/922,677

(22) Filed: Oct. 26, 2015

(30) Foreign Application Priority Data
Dec. 19, 2014 (JP) 2014-257594

(51) Int. Cl. F16K 24/04; F16K 99/00

(52) U.S. Cl. CPC F16K 24/04; F16K 99/0034

(57) ABSTRACT

Provided is a fluid flow device including a flow passage structure including in the interior a micro-channel and an escape flow passage for allowing a fluid to escape from the micro-channel. The micro-channel includes a folded-back flow passage portion that allows the fluid to flow upward before allowing the same to flow downward. The folded-back flow passage portion includes a top portion disposed at the highest position of the folded-back flow passage portion and an upward flow passage portion and a downward flow passage portion with the top portion as a boundary therebetween that allow the fluid to flow upward and downward, respectively, and the escape flow passage is connected to the top portion of the folded-back flow passage portion.

### BACKGROUND OF THE INVENTION

1. Field of the Invention

The present invention relates to a fluid flow device and a method of operating the same.

2. Description of the Related Art

Hitherto, there are known fluid flow devices including micro-channels allowing a fluid to flow, in which predetermined processing using the fluid is performed while allowing the fluid to flow through the micro-channels. As an example of the fluid flow devices, a micro-channel heat exchanger is illustrated in JP 2010-043850 A as described below.

The micro-channel heat exchanger as illustrated in JP 2010-043850 A includes a heat transfer layer for performing a heat exchange, and on the heat transfer layer, a multitude of winding micro-channels through which a fluid enabling the heat exchange to be performed flows are formed. Each winding micro-channel includes a plurality of curved portions that alternately change a flow direction of the fluid to a reverse direction. Each winding micro-channel includes such a plurality of curved portions so that the degree of a pressure drop between inlet and outlet ports of each winding micro-channel is set at a bubble point of the gas or higher, thereby preventing each winding micro-channel from being blocked by the gas.

### SUMMARY OF THE INVENTION

### Technical Problem

Meanwhile, in fluid flow devices, there is a fluid flow device including micro-channels including an upward flow passage portion that allows a fluid to flow upward and a downward flow passage portion that is connected to the upward flow passage portion on a downstream side while folded back from the upward flow passage portion and extending downward, and allows the fluid to flow downward. In such a fluid flow device as illustrated in JP 2010-043850 A, even though the micro-channels include the plurality of curved portions so that the degree of a pressure drop between the inlet and outlet ports of the winding micro-channels is set at a bubble point of the gas or higher, blockage of the downward flow passage portion by the gas may occur.

Specifically, when the gas enters the downward flow passage portion of the micro-channels, a buoyancy force of the gas reversely acts on the fluid flowing downward through the downward flow passage portion. Thus, the gas in the downward flow passage portion can no longer be pushed away by a flow of the fluid, and consequently, blockage of the downward flow passage portion by the gas may occur. Alternately, when not only the gas but also a low-density fluid having a density lower than a density of an object fluid that is allowed to flow to perform processing enters the downward flow passage portion, blockage of the downward flow passage portion by the low-density fluid occurs according to a similar principle.

This invention has been made to solve the problem as described above, and it is an object of the present invention to provide a fluid flow device including the micro-channel including the upward flow passage portion and the downward flow passage portion on the downstream side thereof, in which blockage of the downward flow passage portion by a low-density fluid can be easily dissolved.

### Solution to Problem

To achieve the above object, the fluid flow device according to the present invention is a fluid flow device for performing predetermined processing while allowing a fluid to flow, including: a flow passage structure including in an interior at least one micro-channel for allowing a fluid that is a processing object to flow and at least one escape flow passage for allowing the fluid to escape from the micro-channel; and a discharge switch part configured to be switchable between an allowance state in which the fluid is allowed to be discharged from the escape flow passage and a prevention state in which the fluid is prevented from being discharged from the escape flow passage, in which the micro-channel includes at least one folded-back flow passage portion that allows the fluid to flow upward before allowing the same to flow downward, the folded-back flow passage portion includes a top portion disposed at a highest position of the folded-back flow passage portion, an upward flow passage portion connected to the top portion and allowing the fluid to flow upward and flow into the top portion, and a downward flow passage portion connected to the top portion and allowing the fluid flowing in from the top portion to flow downward, and the escape flow passage is connected to the top portion or a portion adjacent thereto of the folded-back flow passage portion. Note that the portion of the folded-back flow passage portion that is adjacent to the top portion denotes a portion of the folded-back flow passage portion that is located at an upper end or higher of an extent in which, when a low-density fluid having a density lower than a density of the fluid that is a processing object stays in the downward flow passage portion, the low-density fluid substantially stays.

In this fluid flow device, if the downward flow passage portion of the folded-back flow passage portion of the micro-channel is blocked by a low-density fluid, the discharge switch part is switched from the prevention state to the allowance state so that the low-density fluid in the downward flow passage portion is made to ascend without acting contrary to a buoyant force thereof, and the low-density fluid can be discharged through the escape flow passage connected to the top portion disposed at a highest position of the folded-back flow passage portion or the portion adjacent thereto. Accordingly, blockage of the downward flow passage portion by the low-density fluid can be easily dissolved.

In the fluid flow device, the escape flow passage may be connected to the top portion.

According to this configuration, the low-density fluid can be discharged from the top portion disposed at a highest position of the folded-back flow passage portion through the escape flow passage. Accordingly, the low-density fluid in the folded-back flow passage portion can be completely discharged.

In this case, the top portion may extend horizontally, and the escape flow passage may be connected to a part of the top portion to which an upper end of the downward flow passage portion is connected.

In this configuration, in the fluid flow device in which the top portion of the folded-back flow passage portion horizontally extends, the low-density fluid staying in the downward flow passage portion can be discharged from the upper end of the downward flow passage portion directly through the escape flow passage. Accordingly, the low-density fluid can be prevented from flowing from the downward flow passage portion into the top portion that horizontally extends and staying, and requiring time for discharging the low-density fluid can be suppressed. In other words, the low-density fluid in the downward flow passage portion can be smoothly discharged through the escape flow passage.

The fluid flow device may further include a reverse flow device for allowing a fluid to reversely flow in the micro-channel such that the fluid flows upward through the downward flow passage portion.

In this configuration, the low-density fluid in the downward flow passage portion can be forcibly discharged by a flow force of the fluid that has been allowed to reversely flow by the reverse flow device. Accordingly, blockage of the downward flow passage portion by the low-density fluid can be dissolved further assuredly and in a short period.

In the fluid flow device, the at least one folded-back flow passage portion may include a plurality of folded-back flow passage portions, the at least one escape flow passage may include a plurality of escape flow passages provided to correspond to the folded-back flow passage portions, and the discharge switch part may include a plurality of individual switch portions that are provided to correspond to the escape flow passages and each configured to be switchable between an allowance state in which the fluid is allowed to be discharged from the corresponding escape flow passages and a prevention state in which the fluid is prevented from being discharged from the corresponding escape flow passages.

In this configuration, the micro-channel includes the plurality of folded-back flow passage portions so that a long flow passage length of the micro-channel can be ensured. Consequently, processing of the fluid in the micro-channel can be accelerated. Further, in this configuration, the plurality of escape flow passages are provided to correspond to the folded-back flow passage portions and the plurality of individual switch portions are provided to correspond to the escape flow passages so that, if any one of the downward flow passage portions of the folded-back flow passage portions is blocked by the low-density fluid, the individual switch portion corresponding to the blocked downward flow passage portion is switched from the prevention state to the allowance state, thereby discharging the low-density fluid from the blocked downward flow passage portion through the escape flow passage so that blockage of the downward flow passage portion can be dissolved.

In the fluid flow device, preferably, the flow passage structure includes a plurality of layers stacked one upon another, the at least one micro-channel includes a plurality of micro-channels that are formed in each of the layers and arranged in a direction of stacking the plurality of layers, the at least one escape flow passage includes a plurality of escape flow passages that are formed in each of the layers to correspond to the micro-channels and arranged in a direction of stacking the plurality of layers, and the discharge switch part is configured to allow the fluid to be discharged from the plurality of escape flow passages in the allowance state and prevent the fluid from being discharged from the plurality of escape flow passages in the prevention state.

According to this configuration, the stacked-layered shaped fluid flow device capable of increasing a processing volume of the fluid per unit time by allowing at the same time the fluids that are processing objects to flow through the plurality of micro-channels arranged in a direction of stacking each layer can be obtained. Further, in this configuration, the discharge switch part is made to be in the allowance state, thereby being capable of allowing at the same time the fluids to be discharged from the plurality of escape flow passages provided to correspond to the micro-channels, while the discharge switch part is made to be in the prevention state, thereby being capable of preventing at the same time the fluids from being discharged from the plurality of escape flow passages. Thus, switch between a state in which the low-density fluid is allowed be discharged from the downward flow passage portions of the plurality of micro-channels included in the stacked-layered shaped fluid flow device through each of the corresponding escape flow passages and a state in which the fluid is prevented from being discharged through each of the corresponding escape flow passages and the fluids that are processing objects are allowed to flow through each micro-channel can be performed through a switch operation of the discharge switch part, and accordingly, compared with a case in which a switch operation is performed with respect to each individual micro-channel, a switch operation thereof can be simplified.

Moreover, a method of operating the fluid flow device according to the present invention includes: a flow step of supplying to the micro-channel a fluid that is a processing object and allowing the fluid to flow while the discharge switch part is made to be in the prevention state; a supply stop step of stopping supplying to the micro-channel the fluid that is a processing object when the downward flow passage portion is blocked by a low-density fluid having a density lower than a density of the fluid that is a processing object; and a switch step of switching, after the supply stop step, the discharge switch part from the prevention state to the allowance state such that the low-density fluid in the downward flow passage portion flows out through the escape flow passage.

According to this operation method, if the downward flow passage portion is blocked by the low-density fluid when predetermined processing is performed while allowing the fluid that is a processing object to flow in the micro-channel, the blockage can be easily dissolved.

The method of operating the fluid flow device preferably further includes, after the switch step, a reverse flow step of allowing the fluid to reversely flow through the micro-channel such that the fluid flows from the downward flow passage portion to the escape flow passage.

According to this configuration, the low-density fluid in the downward flow passage portion can be forcibly discharged by a flow force of the fluid that has been allowed to reversely flow in the micro-channel. Accordingly, blockage of the downward flow passage portion by the low-density fluid can be dissolved further assuredly and in a short period.

Moreover, the method of operating the fluid flow device according to the present invention is a method of operating the fluid flow device including the plurality of folded-back flow passage portions, the plurality of escape flow passages, and the plurality of individual switch portions, including: a flow step of supplying to the micro-channel a fluid that is a processing object and allowing the fluid to flow while each discharge switch part is made to be in the prevention state; a supply stop step of stopping supplying to the micro-channel the fluid that is a processing object when at least one of the downward flow passage portions of the plurality of folded-back flow passage portions is blocked by a low-density fluid having a density lower than a density of the fluid that is a processing object; and a discharge step of discharging, after the supply stop step, the fluid from the downward flow passage portion of each of the folded-back flow passage portions, in which, in the discharge step, an operation in which the individual switch portion corresponding to the predetermined folded-back flow passage portion is switched from the prevention state to the allowance state before the fluid is allowed to reversely flow through the micro-channel and to be discharged from the downward flow passage portion of the predetermined folded-back flow passage portion through the corresponding escape flow passage, and then, the individual switch portion corresponding to the upstream folded-back flow passage portion that is the folded-back flow passage portion adjacent upstream to the predetermined folded-back flow passage portion is switched from the prevention state to the allowance state before the fluid is allowed to reversely flow through the micro-channel and to be discharged from the downward flow passage portion of the upstream folded-back flow passage portion through the corresponding escape flow passage is performed in order with respect to all the plurality of folded-back flow passage portions from the folded-back flow passage portion on a downstream side to the folded-back flow passage portion on an upstream side.

According to this method of operating the fluid flow device, the low-density fluid in each downward flow passage portion of the plurality of folded-back flow passage portions can be forcibly discharged by a flow force of the fluid that has been allowed to reversely flow in the micro-channel. Accordingly, blockage of each downward flow passage portion by the low-density fluid can be assuredly dissolved. Further, discharging the low-density fluid in the downward flow passage portion through the escape flow passage by allowing the fluid to reversely flow in the micro-channel is performed in order from the folded-back flow passage portion on a downstream side to the folded-back flow passage portion on the upstream side, it can be thereby prevented that the low-density fluid staying in the downward flow passage portion of the folded-back flow passage portion on the downstream side flows into the upward flow passage portion of this folded-back flow passage portion and blocks this upward flow passage portion, and when subsequently discharging the low-density fluid from the downward flow passage portion of the folded-back flow passage portion on the upstream side, allowing the fluid to reversely flow to this downward flow passage portion can no longer be performed. Thus, according to this operation method, forcibly discharging the low-density fluid in all the downward flow passage portions by allowing the fluid to reversely flow can be smoothly performed.

### Advantageous Effects of the Invention

As described above, the present invention provides the fluid flow device including the micro-channel including the upward flow passage portion and the downward flow passage portion disposed on the downstream side thereof, in which blockage of the downward flow passage portion by the low-density fluid can be easily dissolved

### BRIEF DESCRIPTION OF THE DRAWINGS

FIG. 1 is a schematic perspective view of a fluid flow device according to a first embodiment of the present invention.

FIG. 2 is a diagram schematically illustrating a configuration of a flow passage substrate as viewed from a first plate surface side that forms a flow passage structure and configurations of a supply part of a fluid that is a processing object, a discharge part of the fluid that is the processing object, an escape fluid discharge part, and a discharge switch part of the fluid flow device according to the first embodiment of the present invention.

FIG. 3 is a diagram schematically illustrating the configuration of the flow passage substrate as viewed from a second plate surface side that forms the flow passage structure and configurations of the supply part of the fluid that is the processing object, the discharge part of the fluid that is the processing object, the escape fluid discharge part, and the discharge switch part of the fluid flow device according to the first embodiment of the present invention.

FIG. 4 is a diagram that corresponds to FIG. 2, illustrating the fluid flow device according to a second embodiment of the present invention.

### DESCRIPTION OF THE PREFERRED EMBODIMENTS

Hereinafter, embodiments of the present invention will be described in detail with reference to the accompanying drawings.

### First Embodiment

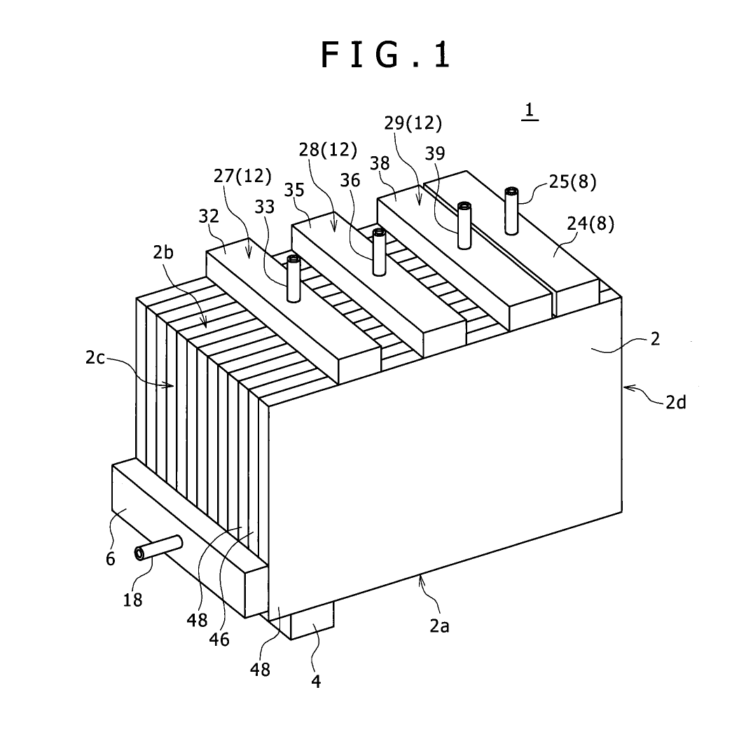

In FIGS. 1-3, a fluid flow device 1 according to a first embodiment of the present invention is illustrated. The fluid flow device 1 is used for a reaction device in which a first fluid and a second fluid are allowed to be chemically reacted with each other while allowed to flow, an extraction device in which a specific component is allowed to be extracted from the first fluid to the second fluid as an extractant while the first fluid and the second fluid are allowed to flow, and the like. Note that the first fluid and the second fluid are an example of fluids that are processing objects in the present invention. Moreover, the chemical reaction between the fluids and the extraction of a specific component from the first fluid to the second fluid are an example of predetermined processing in the present invention.

The fluid flow device 1 according to the first embodiment includes, as illustrated in FIG. 1, a flow passage structure 2, a first supply header 4, a second supply header 6, an object fluid discharge part 8, a discharge valve 10, an escape fluid discharge part 12, a discharge switch part 14, a first supply pipe 15, a first supply pump 16, a first supply valve 17, a second supply pipe 18, a second supply pump 19, a second supply valve 20, a first input side pressure meter 21, a second input side pressure meter 22, and an output side pressure meter 23.

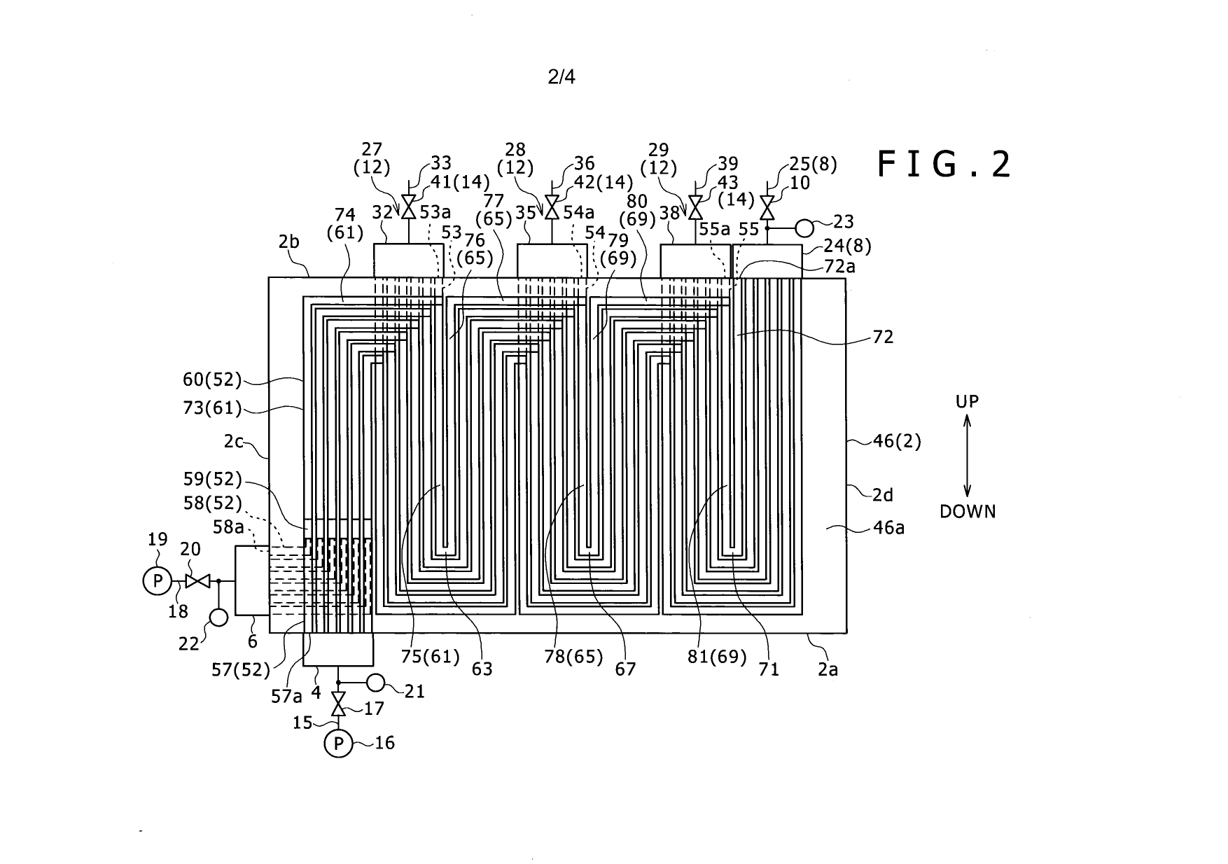

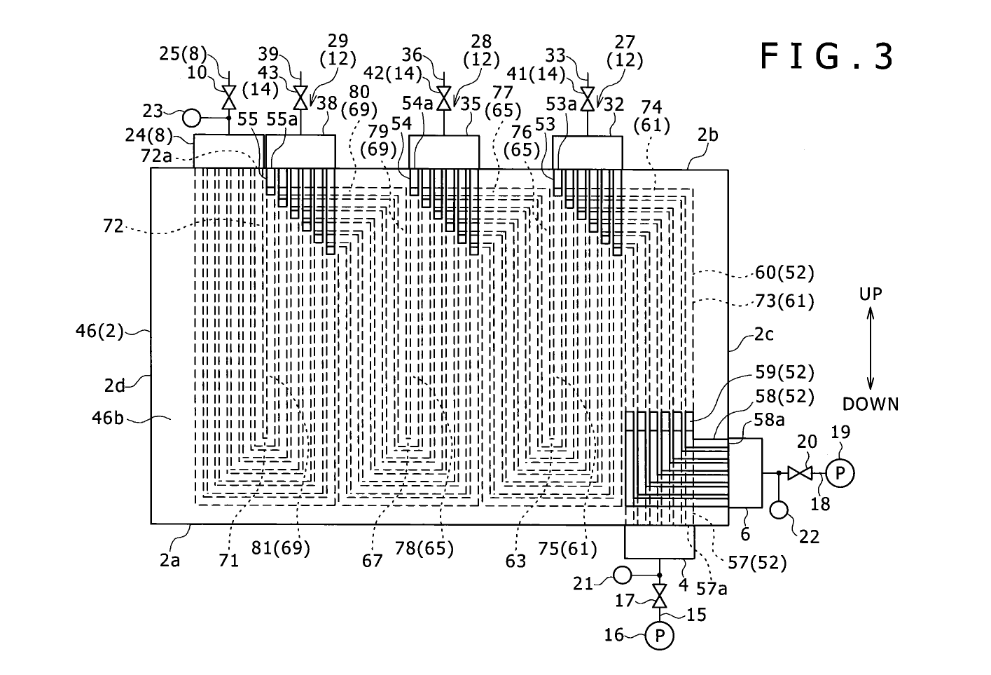

The flow passage structure 2 is a rectangular-prism-shaped structure includes in the interior a multitude of micro-channels 52 (see FIGS. 2 and 3) that allow the first fluid and the second fluid to flow, and a multitude of first to third escape flow passages 53, 54, 55 (see FIGS. 2 and 3) that allow the fluids to escape from the micro-channels 52. The flow passage structure 2 is made of a stacked body in which a multitude of plates are stacked one upon another to be adhered to one another as illustrated in FIG. 1. The multitude of plates forming the flow passage structure 2 are an example of a plurality of layers in the present invention. Each of the plates forming the flow passage structure 2 is rectangular as viewed from one side in a thickness direction thereof and made of a stainless steel plate, for example. The flow passage structure 2 is installed in such a posture that plate surfaces of each of the plates forming the flow passage structure 2 extend in a vertical direction while a long-side direction of each of the plates corresponds to a horizontal direction and a short side direction of each of the plates corresponds to the vertical direction.

The flow passage structure 2 includes a lower surface 2a that faces a lower side, an upper surface 2b that faces an upper side, a first side surface 2c that is disposed vertically relative to the lower surface 2a and the upper surface 2b and faces one side in the long-side direction of each of the plates, and a second side surface 2d that is disposed vertically relative to the lower surface 2a and the upper surface 2b and is a surface on a side opposite to the first side surface 2c. The lower surface 2a, the upper surface 2b, the first side surface 2c and the second side surface 2d are formed by corresponding end surfaces of a periphery portion of each of the plates forming the flow passage structure 2. The plurality of plates forming the flow passage structure 2 includes a plurality of flow passage substrates 46 and a plurality of sealing plates 48.

Each flow passage substrate 46 is a plate in which a plurality of micro-channels 52 (see FIG. 2), a plurality of first escape flow passages 53 corresponding to the plurality of micro-channels 52, a plurality of second escape flow passages 54 corresponding to the plurality of micro-channels 52, and a plurality of third escape flow passages 55 corresponding to the plurality of micro-channels 52 are formed. Each flow passage substrate 46 includes a first plate surface 46a (see FIG. 2) that is one plate surface in the thickness direction thereof and a second plate surface 46b (see FIG. 3) that is a plate surface on a side opposite to the first plate surface 46a. The separate sealing plates 48 (see FIG. 1) are stacked on and adhered to the corresponding first plate surface 46a and second plate surface 46b.

The micro-channels 52 have a minute flow passage diameter of several μm to several mm. Each micro-channel 52 includes, as illustrated in FIGS. 2 and 3, a first supply flow passage portion 57, a second supply flow passage portion 58, a confluence portion 59, and an operation flow passage portion 60.

To the first supply flow passage portion 57, the first fluid is fed. The first supply flow passage portion 57 is a flow passage that leads the fed first fluid to the confluence portion 59. The first supply flow passage portion 57 of each micro-channel 52 is arranged in a manner parallel to each other as illustrated in FIG. 2. The first supply flow passage portion 57 has at one end thereof a first feeding port 57a (see FIG. 2) that receives the first fluid. The first feeding port 57a opens at the lower surface 2a of the flow passage structure 2. The first supply flow passage portion 57 extends upward from the first feeding port 57a in a manner vertical to the lower surface 2a and leads the first fluid such that the fed first fluid flows upward. On each flow passage substrate 46, a minute groove having a shape corresponding to the first supply flow passage portion 57 is formed in such a manner as to open at the first plate surface 46a, and an opening of the groove is sealed by the sealing plate 48 (see FIG. 1) stacked on the first plate surface 46a so that the first supply flow passage portion 57 is formed.

To the second supply flow passage portion 58 (see FIG. 3), the second fluid is fed. The second supply flow passage portion 58 is a flow passage that leads the fed second fluid to the confluence portion 59. The second supply flow passage portion 58 of each micro-channel 52 is arranged in a manner parallel to each other as illustrated in FIG. 3. The second supply flow passage portion 58 has at one end thereof a second feeding port 58a that receives the second fluid. The second feeding port 58a opens at the first side surface 2c of the flow passage structure 2. The second supply flow passage portion 58 extends toward the second side surface 2d from the second feeding port 58a in a manner vertical to the first side surface 2c, bends upward at a position overlapping with the corresponding first supply flow passage portion 57 as viewed from one side in the thickness direction of the flow passage substrate 46, and extends upward. The second supply flow passage portion 58 leads the second fluid such that the fed second fluid flows toward the second side surface 2d before turning upward to flow. On each flow passage substrate 46, a minute groove having a shape corresponding to the second supply flow passage portion 58 is formed in such a manner as to open at the second plate surface 46b, and an opening of the groove is sealed by the sealing plate 48 (see FIG. 1) stacked on the second plate surface 46b so that the second supply flow passage portion 58 is formed.

The confluence portion 59 (see FIG. 2) is a portion for allowing the first fluid led through the corresponding first supply flow passage portion 57 and the second fluid led through the corresponding second supply flow passage portion 58 to join. The confluence portion 59 is connected to an end portion of the corresponding first supply flow passage portion 57 on a side opposite to the first feeding port 57a and an end portion of the corresponding second supply flow passage portion 58 on a side opposite to the second feeding port 58a. In the flow passage substrate 46, a through hole having a shape corresponding to the confluence portion 59 is formed in such a manner as to penetrate in the thickness direction of the flow passage substrate 46. An opening of the through hole on the first plate surface 46a side is sealed by the sealing plate 48 (see FIG. 1) stacked on the first plate surface 46a while an opening of the through hole on the second plate surface 46b (see FIG. 3) side is sealed by the sealing plate 48 stacked on the second plate surface 46b so that the confluence portion 59 is formed.

The operation flow passage portion 60 is connected, as illustrated in FIG. 2, to an upper end of the corresponding confluence portion 59. To the operation flow passage portion 60, the first fluid and the second fluid that have joined in the corresponding confluence portion 59. The operation flow passage portion 60 causes the fed first fluid and second fluid to interact with each other while allowing the same to flow in contact with each other. For example, if the fluid flow device 1 is used as a reaction device, the operation flow passage portion 60 allows the first fluid and second fluid to chemically interact with each other while allowing the same to flow in contact with each other. Alternately, if the fluid flow device 1 is used as an extraction device, the operation flow passage portion 60 allows a specific component to be extracted from the first fluid to the second fluid while allowing the same to flow in contact with each other.

The operation flow passage portion 60 extends upward from the confluence portion 59 along an extension line of the first supply flow passage portion 57 before folded back to extend downward, and then is repeatedly folded back into a meander shape in such a manner as to extend upward and downward, alternately. The operation flow passage portion 60 of each micro-channel 52 is arranged in a manner parallel to each other as illustrated in FIG. 2.

The operation flow passage portion 60 includes a first folded-back flow passage portion 61, a first bottom portion 63, a second folded-back flow passage portion 65, a second bottom portion 67, a third folded-back flow passage portion 69, a third bottom portion 71, and a final upward flow passage portion 72. The first to third folded-back flow passage portions 61, 65, 69 are an example of folded back flow passage portions in the present invention.

The first folded-back flow passage portion 61 is configured in such a manner as to allow a fluid that has flowed in from the confluence portion 59 to flow upward and then to flow downward. This first folded-back flow passage portion 61 includes a first upward flow passage portion 73, a first top portion 74, and a first downward flow passage portion 75.

The first upward flow passage portion 73 is connected to the corresponding confluence portion 59 and linearly extends upward from the confluence portion 59. The first upward flow passage portion 73 allows the fluid that has flowed in from the confluence portion 59 to flow upward to flow into the first top portion 74.

The first top portion 74 is a flow passage portion that is connected to an upper end of the first upward flow passage portion 73 and horizontally extends from this upper end toward the second side surface 2d side. This first top portion 74 is a portion disposed at the highest position of the first folded-back flow passage portion 61. The first top portion 74 leads the fluid that has flowed in from the first upward flow passage portion 73 such that the fluid flows toward the second side surface 2d side.

The first downward flow passage portion 75 is connected to an end portion of the first top portion 74 on a downstream side, that is, the end portion of the first top portion 74 on the second side surface 2d side and extends downward from this end portion. The first downward flow passage portion 75 allows the fluid that has flowed in from the first top portion 74 to flow downward.

The first bottom portion 63 is a flow passage portion that is connected to an end portion of the first downward flow passage portion 75 on the downstream side, that is, a lower end of the first downward flow passage portion 75 and horizontally extends from this lower end toward the second side surface 2d side. The first bottom portion 63 leads the fluid that has flowed in from the first downward flow passage portion 75 such that the fluid flows toward the second side surface 2d side.

The second folded-back flow passage portion 65 is configured in such a manner as to allow the fluid that has flowed in from the first bottom portion 63 to flow upward and then to flow downward. This second folded-back flow passage portion 65 includes a second upward flow passage portion 76, a second top portion 77, and a second downward flow passage portion 78.

The second upward flow passage portion 76 is connected to an end portion of the first bottom portion 63 on the downstream side, that is, the end portion of the first bottom portion 63 on the second side surface 2d side and linearly extends upward from this end portion. The second upward flow passage portion 76 allows the fluid that has flowed in from the first bottom portion 63 to flow upward to flow into the second top portion 77.

The second top portion 77 is connected to an upper end of the second upward flow passage portion 76 and is a flow passage portion that leads the fluid that has flowed in from the second upward flow passage portion 76 such that the fluid flows toward the second side surface 2d side. The second top portion 77 is a portion disposed at the highest position of the second folded-back flow passage portion 65, and has a configuration corresponding to the first top portion 74 in the first folded-back flow passage portion 61.

The second downward flow passage portion 78 is connected to an end portion of the second top portion 77 on the downstream side, and allows the fluid that has flowed in from the second top portion 74 to flow downward. The second downward flow passage portion 78 has a configuration corresponding to the first downward flow passage portion 75 in the first folded-back flow passage portion 61.

The second bottom portion 67 is connected to an end portion of the second downward flow passage portion 78 on the downstream side, that is, a lower end of the second downward flow passage portion 78, and horizontally extends from this lower end toward the second side surface 2d side. The second bottom portion 67 leads the fluid that has flowed in from the second downward flow passage portion 78 such that the fluid flows toward the second side surface 2d side.

The third folded-back flow passage portion 69 is configured in such a manner as to allow the fluid that has flowed in from the second bottom portion 67 to flow upward and then to flow downward. The third folded-back flow passage portion 69 includes a third upward flow passage portion 79, a third top portion 80, and a third downward flow passage portion 81.

The third upward flow passage portion 79 is connected to an end portion of the second bottom portion 67 on the downstream side, and allows the fluid that has flowed in from the second bottom portion 67 to flow upward. The third upward flow passage portion 79 has a configuration corresponding to the second upward flow passage portion 76 in the second folded-back flow passage portion 65.

The third top portion 80 is connected to an upper end of the third upward flow passage portion 79 and is a flow passage portion that leads the fluid that has flowed in from the third upward flow passage portion 79 such that the fluid flows toward the second side surface 2d side. The third top portion 80 is a portion disposed at the highest position of the third folded-back flow passage portion 69, and has a configuration corresponding to the first top portion 74 in the first folded-back flow passage portion 61.

The third downward flow passage portion 81 is connected to an end portion of the third top portion 80 on the downstream side, and allows the fluid that has flowed in from the third top portion 80 to flow downward. The third downward flow passage portion 81 has a configuration corresponding to the first downward flow passage portion 75 in the first folded-back flow passage portion 61.

Note that the first to third upward flow passage portions 73, 76, 79 as described above are an example of upward flow passage portions in the present invention. Moreover, the first to third top portions 74, 77, 80 as described above are an example of top portions in the present invention. In addition, the first to third downward flow passage portions 75, 78, 81 as described above are an example of downward flow passage portions in the present invention.

The third bottom portion 71 is connected to an end portion of the third downward flow passage portion 81 on the downstream side, that is, a lower end of the third downward flow passage portion 81, and horizontally extends from this lower end toward the second side surface 2d side. The third bottom portion 71 leads the fluid that has flowed in from the third downward flow passage portion 81 such that the fluid flows toward the second side surface 2d side.

The most downstream upward flow passage portion 72 is connected to an end portion of the third bottom portion 71 on the downstream side, that is, the end portion of the third bottom portion 71 on the second side surface 2d side, and linearly extends upward from this end portion to reach the upper surface 2b of the flow passage structure 2. The most downstream upward flow passage portion 72 allows the fluid that has flowed in from the third bottom portion 71 to flow upward. The most downstream upward flow passage portion 72 has at an upper end thereof a discharge port 72a for discharging the fluid that has flowed through the most downstream upward flow passage portion 72. The discharge port 72a corresponds to an outlet port of each of the micro-channels 52 for the fluid. The discharge port 72a opens at the upper surface 2b of the flow passage structure 2.

On each flow passage substrate 46, a plurality of minute grooves having a shape corresponding to the operation flow passage portion 60 made of each flow passage portion as described above are formed in such a manner as to open at the first plate surface 46a (see FIG. 2). Further, an opening of each groove is sealed by the sealing plate 48 (see FIG. 1) stacked on the first plate surface 46a so that each operation flow passage portion 60 is formed.

Each first escape flow passage 53 (see FIG. 3) is a flow passage for allowing a low-density fluid having a density lower than densities of the first and second fluids that are processing objects to escape from the first downward flow passage portion 75 of the corresponding micro-channel 52 if the first downward flow passage portion 75 is blocked by the low-density fluid.

Each first escape flow passage 53 is connected to the first top portion 74 of the first folded-back flow passage portion 61 of the corresponding micro-channel 52. Specifically, each first escape flow passage 53 is connected to a part of the first top portion 74 of the corresponding micro-channel 52 to which an upper end of the first downward flow passage portion 75 is connected, that is, the end portion of the first top portion 74 on the second side surface 2d side. Each first escape flow passage 53 linearly extends upward from the part connected to the first top portion 74. Each first escape flow passage 53 is arranged, as illustrated in FIG. 3, in a manner horizontally parallel to each other.

Each first escape flow passage 53 has at an upper end thereof a discharge port 53a for discharging the fluid that has flowed in from the corresponding first downward flow passage portion 75. The discharge port 53a opens at the upper surface 2b of the flow passage structure 2. On each flow passage substrate 46, a plurality of minute grooves having a shape corresponding to each first escape flow passage 53 are formed in such a manner as to open at the second plate surface 46b (see FIG. 3). A lower end of each groove overlaps with the corresponding first top portion 74 as viewed in the thickness direction of the flow passage substrate 46, and is connected to the first downward flow passage portion 75 through a through hole penetrating the flow passage substrate 46 in the thickness direction at this overlapping part. Further, an opening of each groove at the second plate surface 46b is sealed by the sealing plate 48 (see FIG. 1) stacked on the second plate surface 46b so that each first escape flow passage 53 is formed.

Each second escape flow passage 54 (see FIG. 3) is a flow passage for allowing a low-density fluid to escape from the second downward flow passage portion 78 of the corresponding micro-channel 52 if the second downward flow passage portion 78 is blocked by the low-density fluid.

Each second escape flow passage 54 is connected to the second top portion 77 of the second folded-back flow passage portion 65 of the corresponding micro-channel 52. Specifically, each second escape flow passage 54 is connected to a part of the second top portion 77 of the corresponding micro-channel 52 to which an upper end of the second downward flow passage portion 78 is connected, that is, the end portion of the second top portion 77 on the second side surface 2d side. Each second escape flow passage 54 linearly extends upward from the part connected to the second top portion 77. Each second escape flow passage 54 has at an upper end thereof a discharge port 54a for discharging the fluid that has flowed in from the corresponding second downward flow passage portion 78, and this discharge port 54a opens at the upper surface 2b of the flow passage structure 2. A configuration of each second escape flow passage 54 other than that as described above is similar to a configuration of each first escape flow passage 53.

Each third escape flow passage 55 (see FIG. 3) is a flow passage for allowing a low-density fluid to escape from the third downward flow passage portion 81 of the corresponding micro-channel 52 if the third downward flow passage portion 81 is blocked by the low-density fluid.

Each third escape flow passage 55 is connected to the third top portion 80 of the third folded-back flow passage portion 69 of the corresponding micro-channel 52. Specifically, each third escape flow passage 55 is connected to a part of the third top portion 80 of the corresponding micro-channel 52 to which an upper end of the third downward flow passage portion 81 is connected, that is, the end portion of the third top portion 80 on the second side surface 2d side. Each third escape flow passage 55 linearly extends upward from the part connected to the third top portion 80. Each third escape flow passage 55 has at an upper end thereof a discharge port 55a for discharging the fluid that has flowed in from the corresponding third downward flow passage portion 81, and this discharge port 55a opens at the upper surface 2b of the flow passage structure 2. A configuration of each third escape flow passage 55 other than that as described above is similar to a configuration of each first escape flow passage 53.

The first supply header 4 (see FIGS. 1 and 2) is mounted on the lower surface 2a of the flow passage structure 2 in such a manner as to collectively cover the first feeding ports 57a of all the micro-channels 52 provided in the flow passage structure 2. To the first supply header 4, the first supply pipe 15 (see FIG. 2) is connected. To the first supply pipe 15, the first supply pump 16 is connected. The first supply pump 16 supplies the first fluid through the first supply pipe 15 to the first supply header 4. The first supply header 4 distributes the first fluid fed into an interior space of the first supply header 4 from the first supply pipe 15 to each first feeding port 57a, thereby supplying the first fluid.

To the first supply pipe 15, the first supply valve 17 is provided. The first supply valve 17 is configured to be switchable between an opened state in which supplying the first fluid through the first supply pipe 15 to the first supply header 4 is allowed and a closed state in which supplying the first fluid through the first supply pipe 15 to the first supply header 4 is prevented.

To a portion of the first supply pipe 15 between the first supply valve 17 and the first supply header 4, the first input side pressure meter 21 is connected. The first input side pressure meter 21 detects a pressure of the first fluid supplied through the first supply pipe 15 to the first supply header 4. In other words, the first input side pressure meter 21 detects a pressure corresponding to a pressure of the first fluid at the first feeding port 57a of each micro-channel 52.

The second supply header 6 (see FIGS. 1 and 2) is mounted on the first side surface 2c of the flow passage structure 2 in such a manner as to collectively cover the second feeding ports 58a of all the micro-channels 52 provided in the flow passage structure 2. To the second supply header 6, the second supply pipe 18 is connected. To the second supply pipe 18, the second supply pump 19 (see FIG. 2) is connected. The second supply pump 19 supplies the second fluid through the second supply pipe 18 to the second supply header 6. The second supply header 6 distributes the second fluid fed into an interior space of the second supply header 6 from the second supply pipe 18 to each second feeding port 58a, thereby supplying the second fluid.

To the second supply pipe 18, the second supply valve 20 is provided. The second supply valve 20 is configured to be switchable between an opened state in which supplying the second fluid through the second supply pipe 18 to the second supply header 6 is allowed and a closed state in which supplying the second fluid through the second supply pipe 18 to the second supply header 6 is prevented.

To a portion of the second supply pipe 18 between the second supply valve 20 and the second supply header 6, the second input side pressure meter 22 is connected. The second input side pressure meter 22 detects a pressure of the second fluid supplied through the second supply pipe 18 to the second supply header 6. In other words, the second input side pressure meter 22 detects a pressure corresponding to a pressure of the second fluid at the second feeding port 58a of each micro-channel 52.

The object fluid discharge part 8 (see FIG. 2) is a portion that receives the fluid discharged from the discharge port 72a of each micro-channel 52 provided in the flow passage structure 2. The object fluid discharge part 8 includes a discharge header 24 and a discharge pipe 25.

The discharge header 24 (see FIGS. 1 and 2) is mounted on the upper surface 2b of the flow passage structure 2 in such a manner as to collectively cover the discharge ports 72a of all the micro-channels 52 provided in the flow passage structure 2. To the discharge header 24, the discharge pipe 25 is connected. The fluid discharged from the discharge port 72a of each micro-channel 52 joins in an interior space of the discharge header 24 to be discharged through the discharge pipe 25.

The discharge pipe 25 is provided with the discharge valve 10 (see FIG. 2). The discharge valve 10 is configured to be switchable between an opened state in which the fluid is allowed to flow out from the discharge header 24 through the discharge pipe 25, thereby allowing the fluid to be discharged from each discharge port 72a to the interior space of the discharge header 24 and a closed state in which the fluid is prevented from flowing out from the discharge header 24 through the discharge pipe 25, thereby preventing the fluid from being discharged from each discharge port 72a to the interior space of the discharge header 24.

To a portion of the discharge pipe 25 between the discharge valve 10 and the discharge header 24, the output side pressure meter 23 is connected. The output side pressure meter 23 detects a pressure of the fluid discharged through the discharge pipe 25 from the discharge header 24. In other words, the output side pressure meter 23 detects a pressure corresponding to a pressure of the fluid at the discharge port 72a of each micro-channel 52.

The escape fluid discharge part 12 (see FIG. 2) is a portion that receives the fluid discharged from the discharge ports 53a, 54a, 55a of the respective escape flow passages 53, 54, 55 provided in the flow passage structure 2. The escape fluid discharge part 12 includes a first discharge portion 27, a second discharge portion 28, and a third discharge portion 29.

The first discharge portion 27 is mounted on the flow passage structure 2 in such a manner as to receive the fluid discharged from the discharge port 53a of each first escape flow passage 53. The first discharge portion 27 includes, as illustrated in FIG. 2, a first escape header 32 and a first escape pipe 33.

The first escape header 32 is mounted on the upper surface 2b of the flow passage structure 2 in such a manner as to collectively cover the discharge ports 53a of all the first escape flow passages 53 provided in the flow passage structure 2. To the first escape header 32, the first escape pipe 33 is connected. The fluid discharged from the discharge port 53a of each first escape flow passage 53 joins in an interior space of the first escape header 32 to be discharged through the first escape pipe 33.

The second discharge portion 28 is mounted on the flow passage structure 2 in such a manner as to receive the fluid discharged from the discharge port 54a of each second escape flow passage 54. The second discharge portion 28 includes, as illustrated in FIG. 2, a second escape header 35 and a second escape pipe 36.

The second escape header 35 is mounted on the upper surface 2b of the flow passage structure 2 in such a manner as to collectively cover the discharge ports 54a of all the second escape flow passages 54 provided in the flow passage structure 2. To the second escape header 35, the second escape pipe 36 is connected. The fluid discharged from the discharge port 54a of each second escape flow passage 54 joins in an interior space of the second escape header 35 to be discharged through the second escape pipe 36.

The third discharge portion 29 is mounted on the flow passage structure 2 in such a manner as to receive the fluid discharged from the discharge port 55a of each third escape flow passage 55. The third discharge portion 29 includes, as illustrated in FIG. 2, a third escape header 38 and a third escape pipe 39.

The third escape header 38 is mounted on the upper surface 2b of the flow passage structure 2 in such a manner as to collectively cover the discharge ports 55a of all the third escape flow passages 55 provided in the flow passage structure 2. To the third escape header 38, the third escape pipe 39 is connected. The fluid discharged from the discharge port 55a of each third escape flow passage 55 joins in an interior space of the third escape header 38 to be discharged through the third escape pipe 39.

The discharge switch part 14 is provided in the escape fluid discharge part 12. The discharge switch part 14 is configured to be switchable between an allowance state in which the fluid is allowed to be discharged from each of the escape flow passages 53, 54, 55 to the corresponding discharge portions 27, 28, 29 and a prevention state in which the fluid is prevented from being discharged from each of the escape flow passages 53, 54, 55 to the corresponding discharge portions 27, 28, 29. Specifically, the discharge switch part 14 includes a first escape valve 41, a second escape valve 42, and a third escape valve 43. The first to third escape valves 41, 42, 43 are an example of individual switch portions in the present invention.

The first escape valve 41 is provided in the first escape pipe 33 of the first discharge portion 27. The first escape valve 41 is configured to be switchable between an opened state in which the fluid is allowed to be discharged from the first escape header 32 through the first escape pipe 33 and a closed state in which the fluid is prevented from being discharged from the first escape header 32 through the first escape pipe 33.

The second escape valve 42 is provided in the second escape pipe 36 of the second discharge portion 28. The second escape valve 42 is configured to be switchable between an opened state in which the fluid is allowed to be discharged from the second escape header 35 through the second escape pipe 36 and a closed state in which the fluid is prevented from being discharged from the second escape header 35 through the second escape pipe 36.

The third escape valve 43 is provided in the third escape pipe 39 of the third discharge portion 29. The third escape valve 43 is configured to be switchable between an opened state in which the fluid is allowed to be discharged from the third escape header 38 through the third escape pipe 39 and a closed state in which the fluid is prevented from being discharged from the third escape header 38 through the third escape pipe 39. The opened state of each of the escape valves 41, 42, 43 corresponds to the allowance state of the individual switch portions in the present invention, and the closed state of each of the escape valves 41, 42, 43 corresponds to the prevention state of the individual switch portions in the present invention.

Next, a method of operating the fluid flow device 1 according to the first embodiment will be described below.

First, the first supply valve 17, the second supply valve 20, and the discharge valve 10 are set in the opened state, while the first, second, and third escape valves 41, 42, 43 are set in the closed state. In these states, the first supply pump 16 is operated to allow the first supply pump 16 to supply the first fluid to the first supply header 4, while the second supply pump 19 is operated to allow the second supply pump 19 to supply the second fluid to the second supply header 6. Thereby, in each micro-channel 52, the fluids flow from the first and second feeding ports 57a, 58a toward the discharge port 72a.

Specifically, the first fluid supplied to the first supply header 4 is fed from each first feeding port 57a into each corresponding first supply flow passage portion 57, and the second fluid supplied to the second supply header 6 is fed from each second feeding port 58a into each corresponding second supply flow passage portion 58. The first fluid fed into each first supply flow passage portion 57 flows from this first supply flow passage portion 57 into the corresponding confluence portion 59, and the second fluid fed into each second supply flow passage portion 58 flows from this second supply flow passage portion 58 into the corresponding confluence portion 59. Thereby, in each confluence portion 59, the first fluid and the second fluid join.

The first and second fluids that have joined in each confluence portion 59 (hereinafter referred to as “confluence fluid”) flow into the first upward flow passage portion 73 of the operation flow passage portion 60 that corresponds to this confluence portion 59, and flows upward through this first upward flow passage portion 73. Then, the confluence fluid that has flowed through the first upward flow passage portion 73 flows through, in the following order, the first top portion 74, the first downward flow passage portion 75, the first bottom portion 63, the second upward flow passage portion 76, the second top portion 77, the second downward flow passage portion 78, the second bottom portion 67, the third upward flow passage portion 79, the third top portion 80, the third downward flow passage portion 81, the third bottom portion 71, and the most downstream upward flow passage portion 72. Subsequently, the confluence fluid that has flowed through each most downstream upward flow passage portion 72 is discharged from the discharge port 72a to the interior space of the discharge header 24 to join in this interior space, and is discharged through the discharge pipe 25.

After the first fluid and the second fluid join in the confluence portion 59, processing using interaction between the first fluid and the second fluid is performed while the confluence fluid flows through the operation flow passage portion 60. For example, if reactants that can chemically react with each other are used as the first and second fluid, chemical interaction between the first fluid and the second fluid in the confluence fluid occurs as interaction. Alternately, if a fluid containing a specific component is used as the first fluid and an extractant that can extract this specific component is used as the second fluid, extraction of the specific component from the first fluid to the second fluid in the confluence fluid occurs as interaction.

While the confluence fluid flows, a low-density fluid having a density lower than densities of the first and second fluids may be generated due to the interaction between the first fluid and the second fluid. For example, the interaction between the first fluid and the second fluid that are liquids may generate a gas as a low-density fluid. Alternately, a low-density fluid may enter the fluid flow device 1 from the exterior of the fluid flow device 1 and flow into the operation flow passage portion 60. For example, the air as a low-density fluid may enter the fluid flow device 1 and flow into the operation flow passage portion 60. Note that the low-density fluid is not limited to a gas but may be a liquid.

The low-density fluid generated in the operation flow passage portion 60 or the low-density fluid entering the operation flow passage portion 60 from the exterior stays in any one of the first to third downward flow passage portions 75, 78, 81. This is because, in each of the downward flow passage portions 75, 78, 81, a buoyant force of the low-density fluid operates in a direction opposite to a flow direction of the confluence fluid, and as a result, the low-density fluid cannot be pushed away by a flow force of the confluence fluid. Consequently, the downward flow passage portions 75, 78, 81 in which the low-density fluid stays are blocked by the low-density fluid, thereby preventing the confluence fluid from flowing.

Such blockage of the downward flow passage portions 75, 78, 81 is detected through monitoring a total pressure loss in the micro-channels 52 in the flow passage structure 2 that is calculated based on detected pressures of the first and second input side pressure meters 21, 22 and a detected pressure of the output side pressure meter 23.

Specifically, if the fluid flows through the micro-channels 52 in a laminar flow, a pressure loss ΔP is expressed by the following equation:

ΔP=32μuL/d² (1)

where μ represents a viscosity coefficient of the fluid, u represents an average flow velocity of the fluid, L represents a flow passage length of the micro-channel 52, and d represents an equivalent diameter of the micro-channel 52. Provided that the flow passage structure 2 is provided with six pieces of micro-channels 52, if two pieces of micro-channels 52 from thereamong are blocked by a low-density fluid, a total flow passage cross section area of the micro-channels 52 that can be flowed through is accordingly 4/6 times as large as a total flow passage cross section area while all of six pieces of micro-channels 52 are not blocked. In this case, an average flow velocity of the fluid flowing through the micro-channels 52 that can be flowed through is 6/4 times as large as an average velocity of the fluid while all of six pieces of micro-channels 52 are not blocked. Consequently, based on the above equation (1), a pressure loss while two pieces of micro-channels 52 are blocked is determined to be 6/4 times as large as a pressure loss while all of six pieces of micro-channels 52 are not blocked.

Thus, a pressure loss calculated based on a detected pressure of the first input side pressure meter 21 and a detected pressure of the output side pressure meter 23 and a pressure loss calculated based on a detected pressure of the second input side pressure meter 22 and a detected pressure of the output side pressure meter 23 are monitored, and if both of these pressure losses increase, at least one of the micro-channels 52 in the flow passage structure 2 in any one of the downward flow passage portions 75, 78, 81 is determined to be blocked. Note that a pressure loss calculated based on a detected pressure of the first input side pressure meter 21 and a detected pressure of the output side pressure meter 23 corresponds to a differential pressure between a detected pressure of the first input side pressure meter 21 and a detected pressure of the output side pressure meter 23. Moreover, a pressure loss calculated based on a detected pressure of the second input side pressure meter 22 and a detected pressure of the output side pressure meter 23 corresponds to a differential pressure between a detected pressure of the second input side pressure meter 22 and a detected pressure of the output side pressure meter 23.

Then, if it is determined that blockage occurs, the below operations are performed to dissolve the blockage.

First, operations of the first supply pump 16 and the second supply pump 19 are stopped to stop supplying the first fluid to the first supply header 4 and supplying the second fluid to the second supply header 6. In other words, supplying the first fluid to the first feeding port 57a of each micro-channel 52 and supplying the second fluid to the second feeding port 58a of each micro-channel 52 are stopped. Thereby, flowing of the fluid in each micro-channel 52 from the first and second feeding ports 57a, 58a toward the discharge port 72a is stopped.

Subsequently, the first supply valve 17 and the second supply valve 20 are switched from the opened state to the closed state. Meanwhile, the discharge valve 10 is switched from the opened state to the closed state.

Next, the first, second, and third escape valves 41, 42, 43 are switched from the closed state to the opened state. Then, waiting is performed in this state. The low-density fluid that has been blocking any one of the first to third downward flow passage portions 75, 78, 81 in any one of the micro-channels 52 in the flow passage structure 2 ascends from this downward flow passage portion due to a buoyant force, passes through the corresponding escape flow passage 53, 54, 55, and is discharged from the discharge ports 53a, 54a, 55a to the interior spaces of the corresponding escape headers 32, 35, 38. The low-density fluid discharged to the interior spaces of the corresponding escape headers 32, 35, 38 are discharged through the corresponding escape pipes 33, 36, 39.

In such a manner as described above, operations of the fluid flow device 1 according to the first embodiment are performed.

In the first embodiment, as described above, if the downward flow passage portions 75, 78, 81 of the micro-channels 52 are blocked by a low-density fluid, the escape valves 41, 42, 43 are switched from the closed state to the opened state so that the low-density fluid in the downward flow passage portions 75, 78, 81 is made to ascend due to a buoyant force thereof and can be discharged through the corresponding escape flow passages 53, 54, 55, the corresponding escape headers 32, 35, 38, and the corresponding escape pipes 33, 36, 39. In other words, the buoyant force of the low-density fluid does not prevent the low-density fluid in the downward flow passage portions 75, 78, 81 from being discharged, and rather this buoyant force is used so that the low-density fluid in the downward flow passage portions 75, 78, 81 can be discharged. Accordingly, blockage of the downward flow passage portions 75, 78, 81 by the low-density fluid can be easily dissolved. As a result, decrease in processing efficiency of the fluid due to the micro-channels 52 that cannot be flowed through due to blockage of the downward flow passage portions 75, 78, 81 can be easily recovered.

Moreover, in the first embodiment, each of the escape flow passages 53, 54, 55 is connected to the top portions 74, 77, 80 that are disposed at the highest position of the corresponding folded-back flow passage portions 61, 65, 69 so that the low-density fluid in each of the downward flow passage portions 75, 78, 81 can be completely discharged through the corresponding escape flow passages 53, 54, 55.

Further, in this first embodiment, each of the escape flow passages 53, 54, 55 is connected to a part of the corresponding top portions 74, 77, 80 to which an upper end of the respective downward flow passage portions 75, 78, 81 is connected so that the low-density fluid in the downward flow passage portions 75, 78, 81 can be discharged from the upper ends of the downward flow passage portions 75, 78, 81 directly through the corresponding escape flow passages 53, 54, 55. Accordingly, the low-density fluid can be prevented from flowing from the downward flow passage portions 75, 78, 81 into the top portions 74, 77, 80 that horizontally extend and staying, and requiring time for discharging the low-density fluid can be suppressed. In other words, the low-density fluid in each of the downward flow passage portions 75, 78, 81 can be smoothly discharged through the corresponding escape flow passages 53, 54, 55.

Moreover, in the first embodiment, each micro-channel 52 is formed into such a meander shape as to include the plurality of folded-back flow passage portions 61, 65, 69 so that a long flow passage length of the micro-channels 52 can be ensured. Consequently, processing of the fluid in each micro-channel 52 can be accelerated. Further, the low-density fluid can be discharged, as described above, from each of the downward flow passage portions 75, 78, 81 of the plurality of folded-back flow passage portions 61, 65, 69 through the corresponding escape flow passages 53, 54, 55 so that processing of the fluid in the micro-channels 52 is accelerated while blockage of the plurality of downward flow passage portions 75, 78, 81 can be easily dissolved.

Moreover, in the first embodiment, the stacked-layered shaped fluid flow device 1 capable of increasing a processing volume of the fluid per unit time by allowing at the same time the first and second fluids to flow through the multitude of micro-channels 52 arranged in a direction of stacking each substrate forming the flow passage structure 2 can be obtained.

Further, in this first embodiment, switch between a state in which the low-density fluid is allowed be discharged from the downward flow passage portions 75, 78, 81 of the multitude of micro-channels 52 included in the stacked-layered shaped fluid flow device 1 through each of the corresponding escape flow passages 53, 54, 55 and a state in which the fluid is prevented from being discharged through each of the corresponding escape flow passages 53, 54, 55 and the first and second fluids are allowed to flow through each micro-channel 52 can be performed through a switch operation in which each of the escape valves 41, 42, 43 is switched between the opened state and the closed state. Accordingly, compared with a case in which a switch operation is performed with respect to each individual micro-channel 52, a switch operation thereof can be simplified.

### Second Embodiment

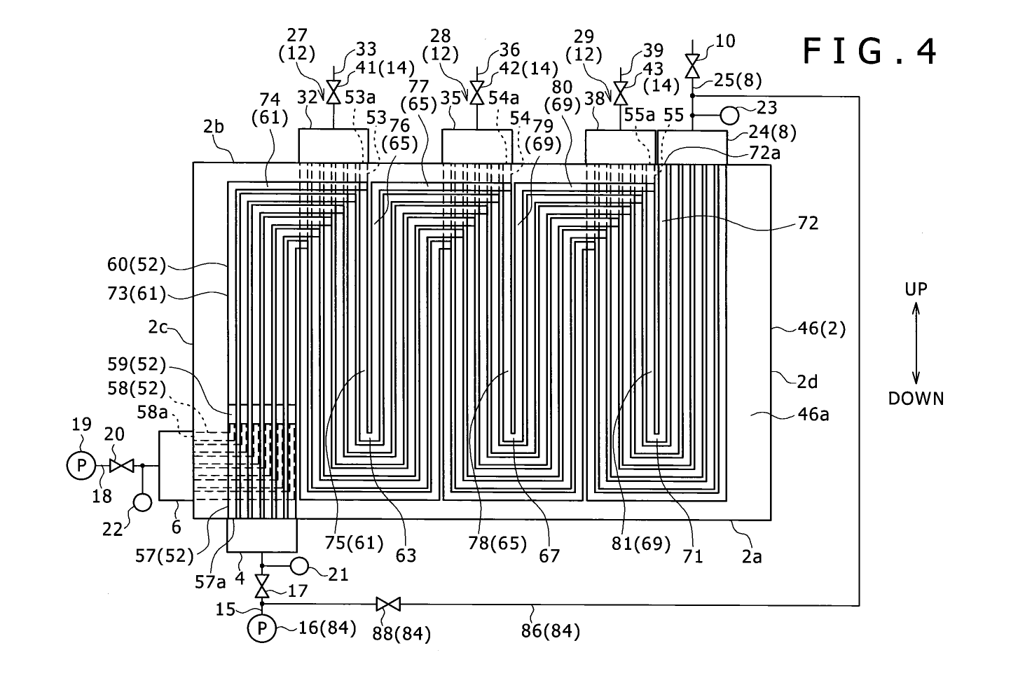

The fluid flow device 1 according to a second embodiment of the present invention will be described with reference to FIG. 4.

The fluid flow device 1 according to this second embodiment is configured in such a manner as to be capable of forcibly discharging a low-density fluid in the downward flow passage portions 75, 78, 81 by allowing a fluid to reversely flow through the micro-channels 52 during operations of the fluid flow device 1 for dissolving blockage of the downward flow passage portions 75, 78, 81 by the low-density fluid.

Specifically, the fluid flow device 1 according to this second embodiment includes a reverse flow device 84 for allowing a fluid to reversely flow in the micro-channels 52. The reverse flow device 84 includes the first supply pump 16, a reverse flow pipe 86, and a reverse flow switch valve 88.

The first supply pump 16 pumps out a fluid for allowing the fluid to reversely flow in the micro-channels 52. In other words, the first supply pump 16 supplies the first fluid to the first supply header 4 during flow operations for normal processing, and in addition, is used also for allowing the fluid to reversely flow in the micro-channels 52 during operations of the fluid flow device 1 for dissolving blockage of the downward flow passage portions 75, 78, 81.

One end of the reverse flow pipe 86 is connected to a portion of the first supply pipe 15 between the first supply pump 16 and the first supply valve 17, and the other end of the reverse flow pipe 86 is connected to a portion of the discharge pipe 25 between the discharge valve 10 and the discharge header 24. To allow the fluid to reversely flow in the micro-channels 52, the reverse flow pipe 86 leads the first fluid that has been pumped out from the first supply pump 16 to the discharge pipe 25, and feeds the same from this discharge pipe 25 through the interior space of the discharge header 24 to the discharge port 72a of each micro-channel 52.

The reverse flow switch valve 88 is provided to the reverse flow pipe 86. The reverse flow switch valve 88 is configured to be switchable between an opened state in which the first fluid that has been pumped out from the first supply pump 16 is allowed to flow through the reverse flow pipe 86 toward the discharge header 24 and a closed state in which the first fluid that has been pumped out from the first supply pump 16 is prevented from flowing through the reverse flow pipe 86 toward the discharge header 24.

A configuration of the fluid flow device 1 according to this second embodiment other than a configuration as described above is similar to a configuration of the fluid flow device 1 according to the first embodiment.

In a method of operating the fluid flow device 1 according to this second embodiment, if blockage of the downward flow passage portions 75, 78, 81 by the low-density fluid occurs, operations of the fluid flow device 1 for dissolving this blockage are performed in the following procedure.

First, operations of the first supply pump 16 and the second supply pump 19 are stopped to stop supplying the first fluid to the first supply header 4 and supplying the second fluid to the second supply header 6. In other words, supplying the first fluid to the first feeding port 57a of each micro-channel 52 and supplying the second fluid to the second feeding port 58a of each micro-channel 52 are stopped. Thereby, flowing of the fluid in each micro-channel 52 from the first and second feeding ports 57a, 58a toward the discharge port 72a is stopped.

Subsequently, the first supply valve 17, the second supply valve 20, and the discharge valve 10 are switched from the opened state to the closed state. Meanwhile, the third escape valve 43 is switched from the closed state to the opened state, while the reverse flow switch valve 88 is switched from the closed state to the opened state. The first and second escape valves 41, 42 are maintained to be in the closed state.

Then, the first supply pump 16 is operated to allow the first supply pump 16 to pump out the first fluid. The first fluid that has been pumped out flows through the reverse flow pipe 86 and the discharge pipe 25 to the discharge header 24, and distributed and fed from the interior space of the discharge header 24 to the discharge ports 72a of each micro-channel 52. Thereby, the first fluid reversely flows from the discharge ports 72a through the operation flow passage portion 60.

If the third downward flow passage portion 81 of any one of the micro-channels 52 in the flow passage structure 2 is blocked by the low-density fluid, the low-density fluid in the blocked third downward flow passage portion 81 is pushed out upward and discharged to the corresponding third escape flow passage 55 by a flow force of the first fluid that reversely flows. Then, the low-density fluid is discharged through the third escape flow passage 55 to the interior space of the third escape header 38 and discharged through the third escape pipe 39.

Allowing the first fluid to reversely flow for discharging the low-density fluid through the third escape pipe 39 is performed for a period several times as long as an average staying period required for the first fluid to pass from the discharge header 24 through the most downstream upward flow passage portion 72, the third bottom portion 71, the third downward flow passage portion 81, the third escape flow passage 55, and the third escape header 38, and reach the third escape valve 43. Then, the first supply pump 16 is stopped to stop allowing the first fluid to reversely flow.

Subsequently, the third escape valve 43 is switched from the opened state to the closed state. Meanwhile, the second escape valve 42 is switched from the closed state to the opened state.

Then, the first supply pump 16 is operated to allow the first supply pump 16 to pump out the first fluid. Thereby, the first fluid reversely flows through the operation flow passage portion 60, and if the second downward flow passage portion 78 of any one of the micro-channels 52 in the flow passage structure 2 is blocked by the low-density fluid, the low-density fluid in the second downward flow passage portion 78 is discharged to the second escape flow passage 54 due to a reverse flow of the first fluid, then the low-density fluid is discharged from this second escape flow passage 54 through the second escape header 35 and the second escape pipe 36. A principle of discharging a low-density fluid in the second downward flow passage portion 78 in this case is similar to a principle of discharging a low-density fluid in the third downward flow passage portion 81 as described above.

Allowing the first fluid to reversely flow for discharging the low-density fluid through the second escape pipe 36 is performed for a period several times as long as an average staying period required for the first fluid to pass from the discharge header 24 through the most downstream upward flow passage portion 72, the third bottom portion 71, the third folded-back flow passage portion 69, the second bottom portion 67, the second downward flow passage portion 78, the second escape flow passage 54, and the second escape header 35, and reach the second escape valve 42. Then, the first supply pump 16 is stopped to stop allowing the first fluid to reversely flow.

Subsequently, the second escape valve 42 is switched from the opened state to the closed state. Meanwhile, the first escape valve 41 is switched from the closed state to the opened state.

Then, the first supply pump 16 is operated to allow the first supply pump 16 to pump out the first fluid, thereby allowing the first fluid to reversely flow through the operation flow passage portion 60. If the first downward flow passage portion 75 of any one of the micro-channels 52 in the flow passage structure 2 is blocked by the low-density fluid, the low-density fluid in the first downward flow passage portion 75 is discharged to the first escape flow passage 53 due to this reverse flow of the first fluid, then the low-density fluid is discharged from this first escape flow passage 53 through the first escape header 32 and the first escape pipe 33. A principle of discharging a low-density fluid in the first downward flow passage portion 75 in this case is similar to a principle of discharging a low-density fluid in the third downward flow passage portion 81 as described above.

Allowing the first fluid to reversely flow for discharging the low-density fluid through the first escape pipe 33 is performed for a period several times as long as an average staying period required for the first fluid to pass from the discharge header 24 through the most downstream upward flow passage portion 72, the third bottom portion 71, the third folded-back flow passage portion 69, the second bottom portion 67, the second folded-back flow passage portion 65, the first bottom portion 63, the first downward flow passage portion 75, the first escape flow passage 53, and the first escape header 32, and reach the first escape valve 41. Then, the first supply pump 16 is stopped to stop allowing the first fluid to reversely flow.

In such a manner as described above, operations of the fluid flow device 1 according to the second embodiment for dissolving blockage of the downward flow passage portions 75, 78, 81 by a low-density fluid are performed. Note that steps of the method of operating the fluid flow device 1 according to the second embodiment other than the steps as described above are similar to steps of the method of operating the fluid flow device 1 according to the first embodiment.

In this second embodiment, the low-density fluid in the downward flow passage portions 75, 78, 81 in the micro-channels 52 can be forcibly discharged by a flow force of the first fluid that has been allowed to reversely flow by the reverse flow device 84. Accordingly, blockage of the downward flow passage portions 75, 78, 81 by the low-density fluid can be further assuredly dissolved.

Moreover, in this second embodiment, discharging the low-density fluid in the downward flow passage portions 75, 78, 81 through the escape flow passages 53, 54, 55 by allowing the first fluid to reversely flow in the operation flow passage portion 60 is performed in order from the third downward flow passage portion 81 on the downstream side to the second downward flow passage portion 78 on an upstream side, and further to the first downward flow passage portion 75 on the upstream side. Accordingly, the low-density fluid in the third downward flow passage portion 81 can be prevented from flowing into the third upward flow passage portion 79 upstream of the third downward flow passage portion 81 to block the third upward flow passage portion 79. Moreover, the low-density fluid in the second downward flow passage portion 78 can be prevented from flowing into the second upward flow passage portion 76 upstream of the second downward flow passage portion 78 to block the second upward flow passage portion 76. Thus, when discharging the low-density fluid in the second downward flow passage portion 78, prevention of reverse flow of the first fluid to the second downward flow passage portion 78 can be prevented, and when discharging the low-density fluid in the first downward flow passage portion 75, prevention of reverse flow of the first fluid to the first downward flow passage portion 75 can be prevented. Consequently, forcibly discharging the low-density fluid in the first and second downward flow passage portions 75, 78 by allowing the first fluid to reversely flow can be smoothly performed.

Note that it should be understood that the embodiments disclosed herein are illustrative and non-restrictive in every respect. The scope of the present invention is defined by the terms of the claims, rather than the description of the embodiments above, and includes any modifications within the scope and meaning equivalent to the terms of the claims.

In each embodiment as described above, each of the escape flow passages 53, 54, 55 is connected to a part of the corresponding top portions 74, 77, 80 to which the upper end of the respective downward flow passage portions 75, 78, 81 is connected, but each escape flow passage may be connected to the corresponding top portion at a part other than such a part. For example, each of the escape flow passages 53, 54, 55 may be connected to a part of the corresponding top portions 74, 77, 80 further the first side surface 2c side of the flow passage structure 2 than the upper end of the respective downward flow passage portions 75, 78, 81. Even in this case, each of the escape flow passages 53, 54, 55 is connected to the highest position of the corresponding folded-back flow passage portions 61, 65, 69. Accordingly, all the low-density fluid in the downward flow passage portions 75, 78, 81 of the respective folded-back flow passage portions 61, 65, 69 can be discharged through the corresponding escape flow passages 53, 54, 55.

Alternately, the escape flow passages may not be connected to the top portions disposed at the highest position of the corresponding folded-back flow passage portions. For example, the escape flow passages may be connected to portions adjacent to the top portions of the corresponding folded-back flow passage portions, namely portions each disposed at a position slightly lower than the top portions. Even in this case, substantially all the low-density fluid staying in the downward flow passage portions of the folded-back flow passage portions can be discharged through the escape flow passages.

Moreover, the arrangement and the shape of the micro-channels are not necessarily limited to those as described in the above embodiments.

For example, the number and the arrangement form of the micro-channels provided in the flow passage structure, the number of folding-backs of the operation flow passage portion of each micro-channel may be variously changed.

Alternately, a part of the operation flow passage portion that ranges from the upward flow passage portion via the top portion to the downward flow passage portion may be formed in a curved manner.

Alternately, the upward flow passage portion and the downward flow passage portion may extend slantwise relative to the vertical direction. Still alternately, the upward flow passage portion and the downward flow passage portion may be formed in a curved manner.

Alternately, the flow passage structure may be made of a transparent material. In this case, the downward flow passage portion of the plurality of downward flow passage portions included in the micro-channel that is blocked by the low-density fluid can be discovered by visual inspection from the exterior of the flow passage structure. In this case, while only the escape valve corresponding to the downward flow passage portion in which this blockage is discovered is made to be in the opened state, the low-density fluid can be discharged from this downward flow passage portion through the corresponding escape flow passage.

Alternately, either the first input side pressure meter 21 or the second input side pressure meter 22 may be omitted. Even in this case, a pressure loss is calculated based on a detected pressure of the remaining input side pressure meter and a detected pressure of the output side pressure meter 23, and the calculated pressure loss is monitored so that blockage of the downward flow passage portion by the low-density fluid can be detected.

Alternately, the output side pressure meter 23 may be omitted. In this case, blockage of the downward flow passage portion can be detected not through monitoring a calculated pressure loss as in the above embodiments but through monitoring detected pressures of the first and second input side pressure meters 21, 22 and based on changes of these detected pressures. In other words, if the downward flow passage portion is blocked by the low-density fluid during flow operations, detected pressures of the first and second input side pressure meters 21, 22 increase so that blockage of the downward flow passage portion can be detected through monitoring these detected pressures.

Alternately, the fluid flow device 1 may include, in place of the first input side pressure meter 21, the second input side pressure meter 22, and the output side pressure meter 23, a differential pressure meter that detects a differential pressure between a pressure of the first fluid supplied to the first supply header 4 and a pressure of the fluid discharged from the discharge header 24 and/or a differential pressure meter that detects a differential pressure between a pressure of the second fluid supplied to the second supply header 6 and a pressure of the fluid discharged from the discharge header 24. In this case, a differential pressure detected by the differential pressure meter corresponds to a total pressure loss of all the micro-channels 52 in the flow passage structure 2 so that blockage of the downward flow passage portion can be detected through monitoring this differential pressure.

Alternately, in the second embodiment as described above, the reverse flow pipe 86 may be connected not to the first supply pipe 15 but to a portion of the second supply pipe 18 between the second supply pump 19 and the second supply valve 20. In this case, the second supply pump 19 is allowed to supply the second fluid through the reverse flow pipe 86 toward the discharge header 24 so that the second flow can be allowed to reversely flow through the micro-channels 52.

Alternately, the first supply pump 16 or the second supply pump 19 may not also serve as a reverse flow pump for allowing the fluid to reversely flow through the micro-channels 52 but a pump exclusively for reverse flow. In other words, the reverse flow device 84 may include a pump exclusively for allowing the fluid to reversely flow in the micro-channels 52.

In this case, a suction portion of the reverse flow pump may be connected to a storage portion in which the first fluid is stored and a discharge portion of the reverse flow pump may be connected to the reverse flow pipe 86. Accordingly, the reverse flow pump can suction the first fluid from the storage portion and pump out the first fluid through the reverse flow pipe 86 toward the discharge header 24, thereby being capable of allowing the first fluid to reversely flow through the micro-channels 52.

Alternately, the suction portion of the reverse flow pump may be connected to a storage portion in which the second fluid is stored and a discharge portion of the reverse flow pump may be connected to the reverse flow pipe 86. In this case, the reverse flow pump can suction the second fluid from the storage portion and pump out the second fluid through the reverse flow pipe 86 toward the discharge header 24, thereby being capable of allowing the second fluid to reversely flow through the micro-channels 52.

What is claimed is:

1. A fluid flow device for performing predetermined processing while allowing a fluid to flow, comprising:
a flow passage structure including in an interior at least one micro-channel for allowing a fluid that is a processing object and at least one escape flow passage for allowing the fluid to escape from the micro-channel; and
a discharge switch part configured to be switchable between an allowance state in which the fluid is allowed to be discharged from the escape flow passage and a prevention state in which the fluid is prevented from being discharged from the escape flow passage,
wherein the micro-channel includes at least one folded-back flow passage portion that allows the fluid to flow upward before allowing the same to flow downward,
the folded-back flow passage portion includes a top portion disposed at a highest position of the folded-back flow passage portion, an upward flow passage portion connected to the top portion and allowing the fluid to flow upward and flow into the top portion, and a downward flow passage portion connected to the top portion and allowing the fluid flowing in from the top portion to flow downward, and
the escape flow passage is connected to the top portion or a portion adjacent thereto of the folded-back flow passage portion.

2. The fluid flow device according to claim 1,
wherein the escape flow passage is connected to the top portion.

3. The fluid flow device according to claim 2,
wherein the top portion extends horizontally, and
the escape flow passage is connected to a part of the top portion to which an upper end of the downward flow passage portion is connected.

4. The fluid flow device according to claim 1, further comprising a reverse flow device for allowing a fluid to reversely flow in the micro-channel such that the fluid flows upward through the downward flow passage portion.

5. The fluid flow device according to claim 2, further comprising a reverse flow device for allowing a fluid to reversely flow in the micro-channel such that the fluid flows upward through the downward flow passage portion.

6. The fluid flow device according to claim 3, further comprising a reverse flow device for allowing a fluid to reversely flow in the micro-channel such that the fluid flows upward through the downward flow passage portion.

7. The fluid flow device according to claim 1,
wherein the at least one folded-back flow passage portion includes a plurality of folded-back flow passage portions,
the at least one escape flow passage includes a plurality of escape flow passages provided to correspond to the folded-back flow passage portions, and
the discharge switch part includes a plurality of individual switch portions that are provided to correspond to the escape flow passages and each configured to be switchable between an allowance state in which the fluid is allowed to be discharged from the corresponding escape flow passages and a prevention state in which the fluid is prevented from being discharged from the corresponding escape flow passages.

8. The fluid flow device according to claim 2,
wherein the at least one folded-back flow passage portion includes a plurality of folded-back flow passage portions,
the at least one escape flow passage includes a plurality of escape flow passages provided to correspond to the folded-back flow passage portions, and
the discharge switch part includes a plurality of individual switch portions that are provided to correspond to the escape flow passages and each configured to be switchable between an allowance state in which the fluid is allowed to be discharged from the corresponding escape flow passages and a prevention state in which the fluid is prevented from being discharged from the corresponding escape flow passages.

9. The fluid flow device according to claim 3,
wherein the at least one folded-back flow passage portion includes a plurality of folded-back flow passage portions,
the at least one escape flow passage includes a plurality of escape flow passages provided to correspond to the folded-back flow passage portions, and
the discharge switch part includes a plurality of individual switch portions that are provided to correspond to the escape flow passages and each configured to be switchable between an allowance state in which the fluid is allowed to be discharged from the corresponding escape flow passages and a prevention state in which the fluid is prevented from being discharged from the corresponding escape flow passages.

10. The fluid flow device according to claim 4,
wherein the at least one folded-back flow passage portion includes a plurality of folded-back flow passage portions,
the at least one escape flow passage includes a plurality of escape flow passages provided to correspond to the folded-back flow passage portions, and
the discharge switch part includes a plurality of individual switch portions that are provided to correspond to the escape flow passages and each configured to be switchable between an allowance state in which the fluid is allowed to be discharged from the corresponding escape flow passages and a prevention state in which the fluid is prevented from being discharged from the corresponding escape flow passages.

11. The fluid flow device according to claim 5,
wherein the at least one folded-back flow passage portion includes a plurality of folded-back flow passage portions,
the at least one escape flow passage includes a plurality of escape flow passages provided to correspond to the folded-back flow passage portions, and
the discharge switch part includes a plurality of individual switch portions that are provided to correspond to the escape flow passages and each configured to be switchable between an allowance state in which the fluid is allowed to be discharged from the corresponding escape flow passages and a prevention state in which the fluid is prevented from being discharged from the corresponding escape flow passages.

12. The fluid flow device according to claim 6,
wherein the at least one folded-back flow passage portion includes a plurality of folded-back flow passage portions,
the at least one escape flow passage includes a plurality of escape flow passages provided to correspond to the folded-back flow passage portions, and
the discharge switch part includes a plurality of individual switch portions that are provided to correspond to the escape flow passages and each configured to be switchable between an allowance state in which the fluid is allowed to be discharged from the corresponding escape flow passages and a prevention state in which the fluid is prevented from being discharged from the corresponding escape flow passages.

13. The fluid flow device according to claim 1,
wherein the flow passage structure includes a plurality of layers stacked one upon another,
the at least one micro-channel includes a plurality of micro-channels that are formed in each of the layers and arranged in a direction of stacking the plurality of layers,
the at least one escape flow passage includes a plurality of escape flow passages that are formed in each of the layers to correspond to the micro-channels and arranged in a direction of stacking the plurality of layers, and
the discharge switch part is configured to allow the fluid to be discharged from the plurality of escape flow passages in the allowance state and prevent the fluid from being discharged from the plurality of escape flow passages in the prevention state.

14. The fluid flow device according to claim 2,
wherein the flow passage structure includes a plurality of layers stacked one upon another,
the at least one micro-channel includes a plurality of micro-channels that are formed in each of the layers and arranged in a direction of stacking the plurality of layers,
the at least one escape flow passage includes a plurality of escape flow passages that are formed in each of the layers to correspond to the micro-channels and arranged in a direction of stacking the plurality of layers, and
the discharge switch part is configured to allow the fluid to be discharged from the plurality of escape flow passages in the allowance state and prevent the fluid from being discharged from the plurality of escape flow passages in the prevention state.

15. The fluid flow device according to claim 3,
wherein the flow passage structure includes a plurality of layers stacked one upon another,
the at least one micro-channel includes a plurality of micro-channels that are formed in each of the layers and arranged in a direction of stacking the plurality of layers,
the at least one escape flow passage includes a plurality of escape flow passages that are formed in each of the layers to correspond to the micro-channels and arranged in a direction of stacking the plurality of layers, and
the discharge switch part is configured to allow the fluid to be discharged from the plurality of escape flow passages in the allowance state and prevent the fluid from being discharged from the plurality of escape flow passages in the prevention state.

16. The fluid flow device according to claim 4,
wherein the flow passage structure includes a plurality of layers stacked one upon another,
the at least one micro-channel includes a plurality of micro-channels that are formed in each of the layers and arranged in a direction of stacking the plurality of layers,
the at least one escape flow passage includes a plurality of escape flow passages that are formed in each of the layers to correspond to the micro-channels and arranged in a direction of stacking the plurality of layers, and
the discharge switch part is configured to allow the fluid to be discharged from the plurality of escape flow passages in the allowance state and prevent the fluid from being discharged from the plurality of escape flow passages in the prevention state.

17. The fluid flow device according to claim 5,
wherein the flow passage structure includes a plurality of layers stacked one upon another,
the at least one micro-channel includes a plurality of micro-channels that are formed in each of the layers and arranged in a direction of stacking the plurality of layers,
the at least one escape flow passage includes a plurality of escape flow passages that are formed in each of the layers to correspond to the micro-channels and arranged in a direction of stacking the plurality of layers, and
the discharge switch part is configured to allow the fluid to be discharged from the plurality of escape flow passages in the allowance state and prevent the fluid from being discharged from the plurality of escape flow passages in the prevention state.

18. The fluid flow device according to claim 6,
wherein the flow passage structure includes a plurality of layers stacked one upon another,
the at least one micro-channel includes a plurality of micro-channels that are formed in each of the layers and arranged in a direction of stacking the plurality of layers,
the at least one escape flow passage includes a plurality of escape flow passages that are formed in each of the layers to correspond to the micro-channels and arranged in a direction of stacking the plurality of layers, and
the discharge switch part is configured to allow the fluid to be discharged from the plurality of escape flow passages in the allowance state and prevent the fluid from being discharged from the plurality of escape flow passages in the prevention state.

19. A method of operating the fluid flow device according to claim 1, comprising:
a flow step of supplying to the micro-channel a fluid that is a processing object and allowing the fluid to flow while the discharge switch part is made to be in the prevention state;
a supply stop step of stopping supplying to the micro-channel the fluid that is a processing object when the downward flow passage portion is blocked by a low-density fluid having a density lower than a density of the fluid that is a processing object; and
a switch step of switching, after the supply stop step, the discharge switch part from the prevention state to the allowance state such that the low-density fluid in the downward flow passage portion flows out through the escape flow passage.

20. The method of operating the fluid flow device, the method according to claim 19, further comprising, after the switch step, a reverse flow step of allowing the fluid to reversely flow through the micro-channel such that the fluid flows from the downward flow passage portion to the escape flow passage.

21. A method of operating the fluid flow device according to claim 7, comprising:
a flow step of supplying to the micro-channel a fluid that is a processing object and allowing the fluid to flow while each discharge switch part is made to be in the prevention state;
a supply stop step of stopping supplying to the micro-channel the fluid that is a processing object when at least one of the downward flow passage portions of the plurality of folded-back flow passage portions is blocked by a low-density fluid having a density lower than a density of the fluid that is a processing object; and
a discharge step of discharging, after the supply stop step, the fluid from the downward flow passage portion of each of the folded-back flow passage portions,
wherein, in the discharge step, an operation in which the individual switch portion corresponding to the predetermined folded-back flow passage portion is switched from the prevention state to the allowance state before the fluid is allowed to reversely flow through the micro-channel and to be discharged from the downward flow passage portion of the predetermined folded-back flow passage portion through the corresponding escape flow passage, and then, the individual switch portion corresponding to the upstream folded-back flow passage portion that is the folded-back flow passage portion adjacent upstream to the predetermined folded-back flow passage portion is switched from the prevention state to the allowance state before the fluid is allowed to reversely flow through the micro-channel and to be discharged from the downward flow passage portion of the upstream folded-back flow passage portion through the corresponding escape flow passage is performed in order with respect to all the plurality of folded-back flow passage portions from the folded-back flow passage portion on a downstream side to the folded-back flow passage portion on an upstream side.

22. The method of operating the fluid flow device according to claim 8, comprising:
a flow step of supplying to the micro-channel a fluid that is a processing object and allowing the fluid to flow while each discharge switch part is made to be in the prevention state;
a supply stop step of stopping supplying to the micro-channel the fluid that is a processing object when at least one of the downward flow passage portions of the plurality of folded-back flow passage portions is blocked by a low-density fluid having a density lower than a density of the fluid that is a processing object; and
a discharge step of discharging, after the supply stop step, the fluid from the downward flow passage portion of each of the folded-back flow passage portions,
wherein, in the discharge step, an operation in which the individual switch portion corresponding to the predetermined folded-back flow passage portion is switched from the prevention state to the allowance state before the fluid is allowed to reversely flow through the micro-channel and to be discharged from the downward flow passage portion of the predetermined folded-back flow passage portion through the corresponding escape flow passage, and then, the individual switch portion corresponding to the upstream folded-back flow passage portion that is the folded-back flow passage portion adjacent upstream to the predetermined folded-back flow passage portion is switched from the prevention state to the allowance state before the fluid is allowed to reversely flow through the micro-channel and to be discharged from the downward flow passage portion of the upstream folded-back flow passage portion through the corresponding escape flow passage is performed in order with respect to all the plurality of folded-back flow passage portions from the folded-back flow passage portion on a downstream side to the folded-back flow passage portion on an upstream side.

23. The method of operating the fluid flow device according to claim 9, comprising:
a flow step of supplying to the micro-channel a fluid that is a processing object and allowing the fluid to flow while each discharge switch part is made to be in the prevention state;
a supply stop step of stopping supplying to the micro-channel the fluid that is a processing object when at least one of the downward flow passage portions of the plurality of folded-back flow passage portions is blocked by a low-density fluid having a density lower than a density of the fluid that is a processing object; and
a discharge step of discharging, after the supply stop step, the fluid from the downward flow passage portion of each of the folded-back flow passage portions,
wherein, in the discharge step, an operation in which the individual switch portion corresponding to the predetermined folded-back flow passage portion is switched from the prevention state to the allowance state before the fluid is allowed to reversely flow through the micro-channel and to be discharged from the downward flow passage portion of the predetermined folded-back flow passage portion through the corresponding escape flow passage, and then, the individual switch portion corresponding to the upstream folded-back flow passage portion that is the folded-back flow passage portion adjacent upstream to the predetermined folded-back flow passage portion is switched from the prevention state to the allowance state before the fluid is allowed to reversely flow through the micro-channel and to be discharged from the downward flow passage portion of the upstream folded-back flow passage portion through the corresponding escape flow passage is performed in order with respect to all the plurality of folded-back flow passage portions from the folded-back flow passage portion on a downstream side to the folded-back flow passage portion on an upstream side.

24. The method of operating the fluid flow device according to claim 10, comprising:
a flow step of supplying to the micro-channel a fluid that is a processing object and allowing the fluid to flow while each discharge switch part is made to be in the prevention state;
a supply stop step of stopping supplying to the micro-channel the fluid that is a processing object when at least one of the downward flow passage portions of the plurality of folded-back flow passage portions is blocked by a low-density fluid having a density lower than a density of the fluid that is a processing object; and
a discharge step of discharging, after the supply stop step, the fluid from the downward flow passage portion of each of the folded-back flow passage portions,
wherein, in the discharge step, an operation in which the individual switch portion corresponding to the predetermined folded-back flow passage portion is switched from the prevention state to the allowance state before the fluid is allowed to reversely flow through the micro-channel and to be discharged from the downward flow passage portion of the predetermined folded-back flow passage portion through the corresponding escape flow passage, and then, the individual switch portion corresponding to the upstream folded-back flow passage portion that is the folded-back flow passage portion adjacent upstream to the predetermined folded-back flow passage portion is switched from the prevention state to the allowance state before the fluid is allowed to reversely flow through the micro-channel and to be discharged from the downward flow passage portion of the upstream folded-back flow passage portion through the corresponding escape flow passage is performed in order with respect to all the plurality of folded-back flow passage portions from the folded-back flow passage portion on a downstream side to the folded-back flow passage portion on an upstream side.

25. The method of operating the fluid flow device according to claim 11, comprising:
a flow step of supplying to the micro-channel a fluid that is a processing object and allowing the fluid to flow while each discharge switch part is made to be in the prevention state;
a supply stop step of stopping supplying to the micro-channel the fluid that is a processing object when at least one of the downward flow passage portions of the plurality of folded-back flow passage portions is blocked by a low-density fluid having a density lower than a density of the fluid that is a processing object; and
a discharge step of discharging, after the supply stop step, the fluid from the downward flow passage portion of each of the folded-back flow passage portions,
wherein, in the discharge step, an operation in which the individual switch portion corresponding to the predetermined folded-back flow passage portion is switched from the prevention state to the allowance state before the fluid is allowed to reversely flow through the micro-channel and to be discharged from the downward flow passage portion of the predetermined folded-back flow passage portion through the corresponding escape flow passage, and then, the individual switch portion corresponding to the upstream folded-back flow passage portion that is the folded-back flow passage portion adjacent upstream to the predetermined folded-back flow passage portion is switched from the prevention state to the allowance state before the fluid is allowed to reversely flow through the micro-channel and to be discharged from the downward flow passage portion of the upstream folded-back flow passage portion through the corresponding escape flow passage is performed in order with respect to all the plurality of folded-back flow passage portions from the folded-back flow passage portion on a downstream side to the folded-back flow passage portion on an upstream side.

26. The method of operating the fluid flow device according to claim 12, comprising:
a flow step of supplying to the micro-channel a fluid that is a processing object and allowing the fluid to flow while each discharge switch part is made to be in the prevention state;
a supply stop step of stopping supplying to the micro-channel the fluid that is a processing object when at least one of the downward flow passage portions of the plurality of folded-back flow passage portions is blocked by a low-density fluid having a density lower than a density of the fluid that is a processing object; and
a discharge step of discharging, after the supply stop step, the fluid from the downward flow passage portion of each of the folded-back flow passage portions,
wherein, in the discharge step, an operation in which the individual switch portion corresponding to the predetermined folded-back flow passage portion is switched from the prevention state to the allowance state before the fluid is allowed to reversely flow through the micro-channel and to be discharged from the downward flow passage portion of the predetermined folded-back flow passage portion through the corresponding escape flow passage, and then, the individual switch portion corresponding to the upstream folded-back flow passage portion that is the folded-back flow passage portion adjacent upstream to the predetermined folded-back flow passage portion is switched from the prevention state to the allowance state before the fluid is allowed to reversely flow through the micro-channel and to be discharged from the downward flow passage portion of the upstream folded-back flow passage portion through the corresponding escape flow passage is performed in order with respect to all the plurality of folded-back flow passage portions from the folded-back flow passage portion on a downstream side to the folded-back flow passage portion on an upstream side.
